(19) United States
(12) Patent Application Publication
(10) Pub. No.: US 2004/0071958 A1
(43) Pub. Date: Apr. 15, 2004

(54) Zinc oxide dispersions in halogen-and water-free dispersion media

(76) Inventors: Thiemo Marx, Viersen (DE); Michael Mager, Leverkusen (DE); Volker Wege, Neuss-Rosellen (DE)

Correspondence Address: BAYER POLYMERS LLC, 100 BAYER ROAD, PITTSBURGH, PA, 15205, US

(21) Appl. No.: 10/667,575

(22) Filed: Sep. 22, 2003

(30) Foreign Application Priority Data
Sep. 23, 2002 (DE) 10244212.6

(51) Int. Cl. B32B 5/16

(52) U.S. Cl. 428/328; 428/323

(57) ABSTRACT

The invention relates to water- and halogen-free dispersions comprising zinc oxide particles in primary-particle-redispersed form and having an average diameter between 1 and 200 nm and aminoalcohols, to a process for the preparation of the dispersions and to the use of this preparation of moulded articles and coatings.

### CROSS REFERENCE TO RELATED PATENT APPLICATION

The present patent application claims the right of priority under 35 U.S.C. §119 (a)-(d) of German Patent Application No. 102 44 212.6, filed Sep. 23, 2002.

### FIELD OF THE INVENTION

The invention relates to Zinc oxide nanoparticle dispersions in which the particles are in primary-particle-dispersed form.

### BACKGROUND OF THE INVENTION

Zinc oxide nanoparticle dispersions in which the particles are in primary-particle-disperse form are known from WO 00/50503. For the preparation, zinc acetate dihydrate (bought or prepared in situ from coarsely particulate zinc oxide, water and glacial acetic acid) is dissolved in methanol, and precipitation of the particles is undertaken by adding base in a suitable stoichiometry. Purification and concentration of the reversibly agglomerated particles produced initially as a slurry takes place by sedimentation, removal of the supernatant, rediluting with fresh methanol with stirring and renewed sedimentation. The formulation of the sols (dispersions, colloidal solutions) takes place subsequently as a result of suitable concentration of the particles to give the gel and redispersion in water and/or organic solvents, optionally with the addition of surface-modifying substances.

Tranparent, highly effective UV-protective coatings based on condensation-crosslinking sol/gel materials can be prepared from zinc oxide in primary-particle-dispersed form (nano-ZnO dispersion) (EP 1 146 069 A2). For this, the anhydrous nano-zinc oxide dispersion in dichloromethane or chloroform described in WO 00/50503 is used. The use of halogenated solvents, however, is prohibitive for commercial marketing of these coatings and also of the sols present.

### SUMMARY OF THE INVENTION

It has now been found that zinc oxide can be redispersed particularly well in aminoalcohols or mixtures of aminoalcohols with halogen- and water-free organic solvents to form a primary-particle-dispersion, and can be formulated to give high-concentration, stable dispersions from which it is possible to produce moulded articles and coatings comprising zinc oxide in primary-particle-dispersed form.

### DETAILED DESCRIPTION OF THE INVENTION

The invention provides water- and halogen-free dispersions which comprise aminoalcohols and zinc oxide in primary-particle-redispersed form (nano-ZnO) with an average particle diameter (determined by means of ultracentrifugation) of from 1 to 200 nm. The dispersions according to the invention consist of the zinc oxide particles in primary-particle-redispersed form and also the water- and halogen-free dispersion medium.

In an embodiment of the invention, as well as the amino alcohols, the mixtures according to the invention comprise nano-zinc oxide with an average particle diameter, determined by means of ultracentrifugation, between 5 and 50 nm, in some cases between 5 and 20 nm.

Information relating to the determination of the particle size by ultracentrifuge measurements is given, for example, in H. G. Müller, Colloid. Polym. Sci., 267, 1113-1116 (1989).

For the purposes of the invention, zinc oxide in primary-particle-redispersible or -redispersed form means that the proportion of the zinc oxide used which cannot be broken up again into its primary particles or is not present in broken-up form in the dispersion in question constitutes less than 15% by weight, in particular less than 1% by weight, of the total amount of the zinc oxide used.

In an embodiment of the invention, the water- and halogen-free dispersion medium contains essentially pure aminoalcohols or mixtures thereof with water- and halogen-free solvents. The proportion of the water- and halogen-free solvent of the total amount of dispersion medium is between 0 and 96% by weight.

In another embodiment of the invention, the aminoalcohols used can be aminoalcohols of the formula (I).

R¹R²N—(CH₂)ₓ—OH (I),

where

R¹ and R², independently of one another, are a C₁-C₃₀-alkyl radical, or constituent of an aliphatic or aromatic C₅-C₂₀-radical or correspond to the radical —(CH₂)ₓ—OH, and

x is an integer from 1 to 30.

In a particular embodiment of the invention, R1 and R2 in formula (I) is the radical (CH₂)ₓ—OH, where x is 2, 3 or 4, in particular triethanolamine.

Examples of aminoalcohols that can be used in the present invention include, but are not limited to:

(HO—CH₂—CH₂)₂N—CH₂—CH₂—N(CH₂—CH₂—OH)₂, N(CH₂—CH₂—OH)₃, HO—CH₂—CH₂—CH₂—N(CH₂—CH₂—OH)₂, HO—CH(CH₃)—CH₂—CH₂—N(CH₂—CH₂—OH)₂, H—N(CH₂—CH₂—OH)₂, CH₃—N(CH₂—CH₂—OH)₂, CH₃—CH₂—N(CH₂—CH₂—OH)₂, CH₃—CH₂—CH₂—N(CH₂—CH₂—OH)₂, (CH₃)₂CH—N(CH₂—CH₂—OH)₂, (CH₃)₃C—N(CH₂—CH₂—OH)₂, C₆H₅—CH₂—N(CH₂—CH₂—OH)₂, C₆H₅—N(CH₂—CH₂—OH)₂, CH₃—(CH₂)₅—N(CH₂—CH₂—OH)₂, CH₃—(CH₂)₁₇—N(CH₂—CH₂—OH)₂, H₂N—CH₂—CH₂—CH₂—N(CH₂—CH₂—OH)₂, H₂N—CH₂—CH₂—OH, (CH₃)₂N—CH₂—CH₂—OH, CH₃—NH—CH₂—CH₂—OH, (CH₃—CH₂)₂N—CH₂—CH₂—OH, (CH₃)₂N—(CH₂)₂—OH, (CH₃)₂N—(CH₂)₃—OH, (CH₃)₂N—(CH₂)₄—OH, CH₃—(CH₂)₃—N(CH₃)—CH₂—CH₂—OH, C₆H₅—CH₂—N(CH₃)—CH₂—CH₂—OH, (CH₃)₂N—CH₂—CH₂—N(CH₃)—CH₂—CH₂—OH, CH₃—(CH₂)₂—N(CH₃)—CH₂—CH₂—OH, H₂N—CH₂—CH₂—N(CH₃)—CH₂—CH₂—OH.

In an embodiment of the present invention, the water- and halogen-free solvents used are alcohols, esters and/or ketones, and in a particular embodiment C₂- to C₆-monoalcohols.

The zinc oxide concentrations of the particles in primary-particle-redispersed form within the dispersion medium are generally between 0.1 and 75% by weight, in some cases 10 and 50% by weight, and in other cases 20 and 40% by weight.

The novel dispersions of particles in primary-particle-redispersed form are notable in that they are storage-stable and, even after weeks and months, do not show any tendency towards particle agglomeration, solids precipitation, separation, gelling, solidification, discoloration and/or curing.

The zinc oxide dispersions according to the invention can be prepared by dispersing a zinc oxide in primary-particle-redispersible form in the dispersion medium.

In a particular embodiment of the invention, zinc oxides in primary-particle-redispersible form are used in the form of methanolic suspensions or gels which have been prepared, for example, in accordance with WO 00/50503. The zinc oxide concentrations here are generally between 5 and 75% by weight, in some cases between 25 and 50% by weight. The conductivity of the methanolic liquid phase is less than 200 mS/cm, in some cases less than 10 mS/cm.

In a particular embodiment, methanol present in the dispersions according to the invention is removed by distillation following introduction of the zinc oxide, which improves the dispersion state of the particles, as is evident from increasing translucency of the dispersion.

The degree of dispersion of the particles can be improved using homogenization processes which form part of the prior art, which use devices such as high-speed stirrers (e.g. IKA-Ultra-Turrax® T25 basic, IKA-Werke GmbH & Co KG, D-79219 Staufen), ultrasound dispersers (e.g. UP200S, UP400S, Dr. Hielscher GmbH, D-14513 Berlin) and/or jet dispersers (Chem. Ing. Tech. (69), June 1997, pp. 793-798; EP 07667997).

The zinc oxide particle dispersions according to the invention can be used to prepare UV-absorbing and/or biocidal coatings and/or moulded articles. Coatings are understood as meaning polymer systems for coating materials such as, for example, metals, plastics or glass, and also creams, ointments, gels or similar solid or flowable formulations for use in the cosmetic or pharmaceutical sector.

An embodiment of the invention is directed to moulded articles which comprise inorganic and/or organic polymers, and zinc oxide particles in primary-particle-dispersed form.

A further embodiment of the invention is directed to coatings which comprise inorganic and/or organic polymers, and zinc oxide particles in primary-particle-dispersed form.

The organic polymers can be polyurethanes, polyacrylates, polyamides and/or polyesters, in particular polycarbonates.

The inorganic polymers can be condensation-crosslinked sol/gel materials.

### EXAMPLES

The ultracentrifuge measurements were carried out on about 0.5% strength by weight ZnO dispersions in a dispersion medium of ethylene glycol/water (weight ratio 2:1).

The TEM imagings were carried out using ZnO dispersions in ethylene glycol/water (weight ratio 2:1), which were dripped onto a carbon-TEM grid, evaporated and then analysed.

The dispersion according to the invention was characterized by recording and evaluating the UV absorption spectrum of the ZnO particles, preferably in the range between 450 and 300 nm. For this purpose, a sample of the dispersion was diluted in ethylene glycol/water (weight ratio 2:1) to 1/500 and measured against a pure mixture of ethylene glycol/water (weight ratio 2:1). Qualitative statements regarding the degree of fineness of the dispersion are obtained by dividing the extinction of the sample at 350 nm (E₃₅₀, absorption range of zinc oxide, transmission losses by scattering and absorption) by that at 400 nm (E₄₀₀, outside the absorption range of zinc oxide, transmission losses exclusively as a result of scattering). For very small particles which cause no transmission losses as a result of light scattering, E₃₅₀/E₄₀₀ is very large; by contrast, smaller values are obtained if E₄₀₀ increases as a result of light scattering in the case of large particles or agglomerates.

The polyfunctional organosilane used in the experiments below was oligomeric cyclo-{OSi[(CH₂)₂Si(OC₂H₅)₂(CH₃)]}₄ (D4-diethoxide oligomer). Its preparation was carried out as described in U.S. Pat. No. 6,136,939, Example 2.

The substrates used were extruded polycarbonate plates (Makrolon® 3103, Bayer AG, Leverkusen). Prior to coating, the plates were cut to a format of 10×10 cm, cleaned by rinsing with isopropanol and provided with an adhesion promoter. The adhesion promoter, an alkoxysilane-modified polyurethane, was prepared as follows:

a) Preparation of the Polyol Component:

9.24 g of a highly branched, hydroxyl group-containing polyester with an OH content in accordance with DIN 53240/2 of 8.6±0.3% by weight and an equivalent weight of about 200 g/mol (Desmophen® 800, Bayer AG) were dissolved with stirring in 3.08 g of n-butyl acetate with 3.08 g of a slightly branched, hydroxyl group-containing polyester with an OH content in accordance with DIN 53240/2 of 4.3±0.4% by weight and an equivalent weight of about 395 g/mol (Desmophen® 670, Bayer AG), then 0.4 g of a 10% strength by weight solution of zinc(II) octoate in diacetone alcohol, 0.2 g of a 10% strength by weight solution of a flow auxiliary (Baysilone® OL 17, GE Bayer Silicones, Leverkusen) in diacetone alcohol, and 170.5 g of diacetone alcohol were added. This gave 186.5 g of the clear, colourless and storage-stable polyol component.

b) Preparation of the Polyisocyanate Component:

462.4 g of an aliphatic polyisocyanate (IPDI trimer) with a NCO content in accordance with DIN EN ISO 11909 of 11.9±0.4% by weight and an equivalent weight of 360 g/mol (Desmodur® Z 4470 (70% strength by weight in n-butyl acetate, Bayer AG) were diluted with 27.23 g of n-butyl acetate, then, over the course of about 2 h, 60.4 g of n-butylaminopropyltrimethoxysilane were added dropwise such that the reaction temperature (internal thermometer) did not exceed 40° C. After cooling, 550 g of the clear, pale yellow and storage-stable polyisocyanate component were obtained.

c) Preparation of the Ready-to-Process Adhesion Promoter

To prepare the ready-to-process adhesion promoter, 42.3 g of component a) and 7.7 g of component b) were mixed with stirring; the resulting clear solution was processed within one hour.

The adhesion promoter, prepared as described, was applied by spin coating (2000 rpm, 20 sec hold time), then it was treated thermally for 60 min at 130° C. The layer thickness obtained in this way was typically about 0.3-0.6 μm. Application of the UV protection formulations according to the invention was carried out within an hour of the adhesion promoter curing.

### Example 1

(Modification of the Preparation of Nano-ZnO Slurries in Accordance with WO 00/50503)

240.35 g of zinc oxide (technical-grade, 99.8% by weight) were initially introduced into 1320 g of methanol (technical-grade, 99.9% by weight) and heated to 50° C. By adding 355.74 g of glacial acetic acid (technical-grade, 99.9% by weight) and 51.15 g of demineralized water, the solid was dissolved and then heated to 60° C. To remove undissolved fractions of ZnO, a total of 34.36 g of KOH (technical-grade, 90.22% by weight) was added in 3 portions. After after-stirring for 40 minutes, a solution of 290.00 g of KOH (technical-grade, 90.22% by weight) in 660.00 g of methanol was added over the course of 8 min. Throughout the entire precipitation operation, the reaction temperature was 60° C. After an ageing time of 35 min., the reaction mixture was cooled to room temperature by external ice cooling. The ZnO particles sedimented overnight and the salt-containing supernatant could be drawn off. Then, the amount of methanol removed was replaced by fresh methanol, the mixture was stirred up again for 10 minutes and left to sediment for 12 h. This washing procedure was repeated twice more until the conductivity of the methanolic supernatant was 3 mS/cm. Following complete removal of the clear methanolic supernatant, a 34.8% strength by weight methanolic zinc oxide slurry was obtained.

### Example 2

28.7 g of a nano-ZnO slurry prepared in accordance with Example 1 (34.8% by weight of ZnO, conductivity of the liquid phase 3 mS/cm) was admixed with 71.3 g of a 4% strength by weight solution of triethanolamin in n-butanol with stirring. The UV-spectroscopic characterization produced an extinction ratio E₃₅₀/E₄₀₀ of 109.

### Example 3

71.6 g of a nano-ZnO slurry prepared [lacuna] Example 1 (34.8% by weight of ZnO, conductivity of the liquid phase 3 mS/cm) were admixed with 28.4 g of a 4% strength by weight solution of triethanolamine in n-butanol with stirring. The UV-spectroscopic characterization produced an extinction ratio E₃₅₀/E₄₀₀ of 91.

### Example 4

To improve the degree of dispersion of the primary particles, dispersions prepared in accordance with Examples 2 and 3 were homogenized by triple treatment in each case with a jet disperser at 1500 bar. In this way, it was possible to improve the extinction ratio E₃₅₀/E₄₀₀ of the dispersion from Example 2 to 250, and from Example 3 to 175.

### Example 5

412.0 g of a nano-ZnO slury prepared analogously to Example 1 (33.1% by weight of ZnO, conductivity of the liquid phase 3 mS/cm) was admixed with 545.48 g of a 4% strength by weight solution of triethanolamine in n-butanol with stirring. Then, at a water bath temperature of 50° C. and a pressure of 100 mbar, 275.63 g of low-boiling components was distilled off to remove the methanol. The UV-spectroscopic characterization produced an extinction ratio E₃₅₀/E₄₀₀ of 100. High-pressure homogenization using a jet disperser (single pass, 400 bar) led to an increase to 199.

### Example 6

60 g of triethanolamine were mixed, with stirring, with 105.1 g of a methanolic zinc oxide slurry (37.1% by weight of ZnO, conductivity of the liquid phase 3 mS/cm) prepared analogously to Example 1. The methanol present was then distilled off on a rotary evaporator at a water bath temperature of 50° C. (vacuum 200 mbar), giving a translucent storage-stable sol. The UV-spectroscopic characterization produced an extinction ratio E₃₅₀/E₄₀₀ of 117.

### Example 7

100 g of a dispersion prepared in accordance with Example 6 in triethanolamine was mixed, with stirring, with 100 g of n-butanol, giving a 19.9% strength by weight translucent, storage-stable sol. The UV-spectroscopic characterization produced an extinction ratio E₃₅₀/E₄₀₀ of 360.

### Example 8

### Preparation of a UV Protection Formulation with Nano-ZnO

With stirring, 13.98 g of oligomeric cyclo-SiO(CH₃)[(CH₂CH₂Si(CH₃)(OC₂H₅)₂]}₄ (D4-diethoxide oligomer) were initially introduced into 50 g of 1-methoxy-2-propanol, and 26.5 g of tetraethoxysilane and 0.1 g of flow auxiliary (Tegoglide® 410, Goldschmidt AG, Essen) were added. 3.4 g of 0.1 n p-toluenesulfonic acid were then added, and the mixture was stirred for 30 min at room temperature before 38.87 g of a nano-zinc oxide dispersion prepared as in Example 2 and homogenized as in Example 4 (amount corresponds to 10 g of dry ZnO) were added dropwise. The coating is then filtered through a fluted filter.

### Example 9

### Removal of the Low-Boiling Components from the UV Protection Formulation from Example 8

In order to free the UV protection formulation prepared in accordance with Example 8 from low-boiling toxic constituents such as methanol, 60 g of n-butanol were added and then 60 g of low-boiling components were distilled off at a water bath [lacuna] of 50° C. and a pressure of 200 mbar.

### Example 10

### Preparation of a Further UV Protection Formulation with Nano-ZnO

3.6 g of a 0.1 n, aqueous p-toluenesulfonic acid solution were added, with stirring, to a mixture of 18.9 g of D4-diethoxide oligomer, 26.6 g of tetraethoxysilane and 35.6 g of 1-methoxy-2-propanol. After stirring for 60 minutes, 57.8 g of a nano-ZnO sol, prepared as described in Example 5, were then added, and after stirring for 15 minutes, finally, a further 15.0 g of aluminium tributoxide complexed with acetoacetic acid in 1-methoxy-2-propanol. (prepared by adding 4.28 g of ethyl acetoacetate to a mixture of 8.1 g of aluminium tri^{sec}butoxide and 2.63 g of 1-methoxy-2-propanol with stirring). This gave a UV protection formulation with 35% by weight of nano-ZnO, calculated on the basis of the solids.

### Example 11

### Preparation of UV-Protective Coatings on Glass and Polycarbonate

The UV protection formulation prepared according to Example 10 was applied by spin coating (maximum speed 500 rpm, 20 seconds hold time) onto polycarbonate plates provided as described with an adhesion promoter. After curing, 60 minutes at 125° C., an optically faultless film having good adherence was obtained.

To measure the UV/VIS absorption spectra, the UV protection formulation prepared as in Example 10 was likewise applied to glass, where the application takes place by spin coating at 4 different maximum speeds (200, 400, 600 and 800 rpm). In this way, after curing (60 min at 125° C.), 4 glass plates with varying layer thicknesses were obtained.

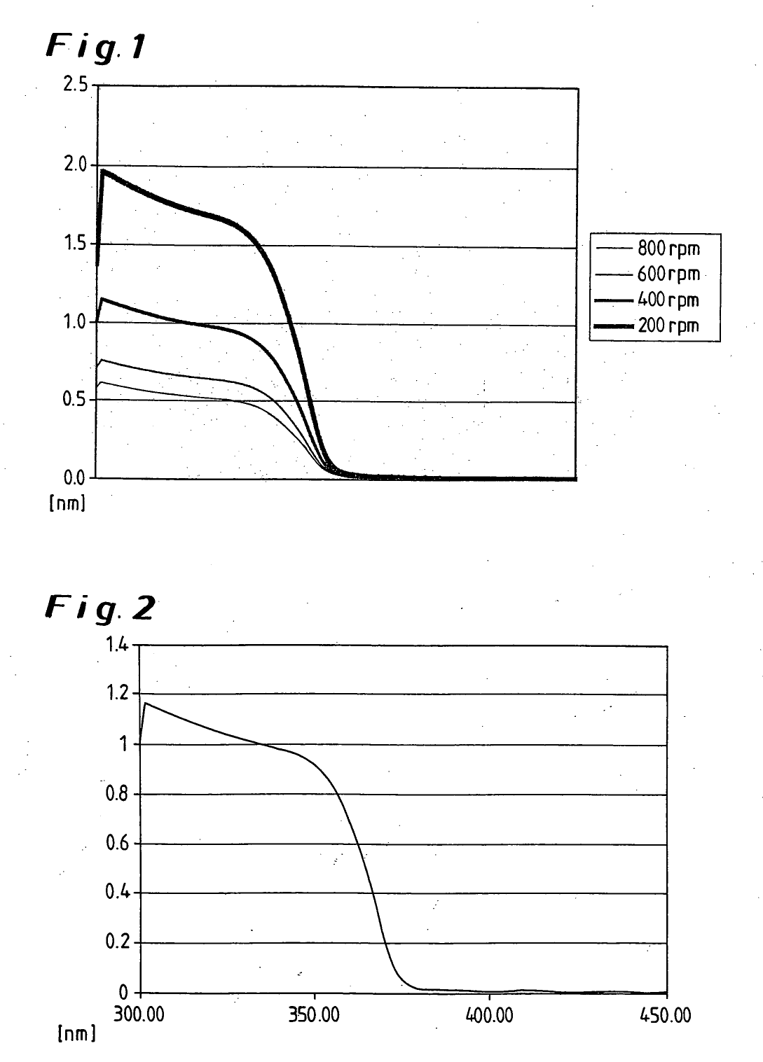

As can be seen from the absorption spectra (see FIG. 1), the coatings prepared in this way ensure excellent UV protection below about 375 nm (high extinction and sharp extinction edge) and have no scattering or absorption of any kind in the visible light region.

### Example 12

### Preparation of a UV-Protective Coatings with Nano-ZnO in Organic Binder

40.42 g of a hydroxyl group-containing polyacrylate with an OH content in accordance with DIN 53240/2 of 3.2±0.4% by weight and an equivalent weight of 530 g/mol (Desmophen® A 665 (70% strength by weight in butyl acetate), Bayer AG) were dissolved in 11.41 g of a 1:1 mixture of 1-methoxypropyl 2-acetate and Solvent Naphtha 100 (relatively high-boiling aromatic mixture, Exxon Chemie GmbH, Hamburg) and then admixed with stirring with an aliphatic, crosslinking stoved urethane resin with a blocked NCO content of 10.5% by weight and an equivalent weight of about 400 g/mol (Desmodur® VP LS 2253 (75% strength by weight in 1-methoxypropyl 2-acetate and Solvent Naphtha 100 (8:17), Bayer AG). Then, 0.49 g of each of Baysilone® OL17 (10% strength by weight in xylene) (GE Bayer Silicones, Leverkusen) and Modaflowe® (1% by weight in xylene), (Solutia Germany GmbH, Mainz) as flow auxiliaries, and also 4.9 g of dibutyltin dilaurate were added. After stirring for 30 minutes, 103.4 g of a 20.3% strength by weight ZnO dispersion in butanol/TEA (96:4) (prepared in accordance with Example 5) were added and the mixture was stirred for a further 10 min.

Then, the application-ready coating system were obtained as storage-stable liquid.

### Example 13

### Preparation of UV-Protective Coatings on Glass and Polycarbonate

The UV protection formulation prepared in accordance with Example 12 was applied by spin coating (maximum speed 1500 rpm, 20 seconds hold time) to polycarbonate plates provided as described with an adhesion promoter. After curing, 60 minutes at 130° C., an optically faultless film having good adherence was obtained.

To measure the UV/VIS absorption spectrum, the UV protection formulation prepared in accordance with Example 12 was likewise applied to glass, application being by spin coating (maximum speeds 1000 rpm, 20 seconds hold time). After curing (60 min at 130° C.), an optically faultless film having good adherence was obtained.

As can be seen from the absorption spectrum (see FIG. 2), the coating prepared in this way ensures an excellent UV protection (high extinction and sharp extinction edge) below about 375 nm and has no scattering or absorption of any kind in the visible light region.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A water- and halogen-free dispersion comprising zinc oxide particles in primary-particle-redispersed form having a diameter of between 1 and 200 nm, and aminoalcohols.

2. The dispersion according to claim 1, further comprising one or more halogen-free organic solvents.

3. A process for preparing a water- and halogen-free zinc oxide dispersions comprising adding zinc oxide particles in primary-particle-redispersible form, with stirring, to aminoalcohols or aminoalcohol-containing, anhydrous organic solvents.

4. A moulded articles prepared using the dispersion according to claim 1.

5. A coating composition comprising the dispersion of claim 1.
